(19) United States
(12) Patent Application Publication
(10) Pub. No.: US 2013/0302621 A1
(43) Pub. Date: Nov. 14, 2013

(54) DECORATIVE ARTICLE AND DEVICE HOUSING USING THE DECORATIVE ARTICLE

(71) Applicants: WU LI, Shenzhen City (CN); DA-QING HUANG, Shenzhen City (CN); DONG-SHENG WENG, Shenzhen City (CN); PENG-SONG LI, Shenzhen City (CN); ZHANG-QI LI, Shenzhen City (CN); QIANG WEI, Shenzhen City (CN); QIANG ZHANG, Shenzhen City (CN)

(72) Inventors: WU LI, Shenzhen City (CN); DA-QING HUANG, Shenzhen City (CN); DONG-SHENG WENG, Shenzhen City (CN); PENG-SONG LI, Shenzhen City (CN); ZHANG-QI LI, Shenzhen City (CN); QIANG WEI, Shenzhen City (CN); QIANG ZHANG, Shenzhen City (CN)

(21) Appl. No.: 13/663,497

(22) Filed: Oct. 30, 2012

(30) Foreign Application Priority Data
May 10, 2012 (CN) 201210143462.X

(51) Int. Cl. B32B 15/09; B32B 15/085

(52) U.S. Cl. 428/412; 428/447

(57) ABSTRACT

A decorative article includes a plastic film, a metallic layer located on the plastic film, and a decorative ink layer located on the metallic layer. The metallic layer contains silicon oxygen bonds. The decorative ink layer contains polyester ink and siloxane coupling agent. A device housing using the decorative article is also described.

### BACKGROUND

1. Technical Field

The present disclosure relates to decorative article and a device housing using the decorative article.

2. Description of Related Art

In-molding labeling (IML) process is a typical method to produce decorative device housings. The process is carried out by molding a plastic substrate into combination with a plastic film in a mold. Prior to the substrate being molded, a metallic layer (such as a silicon dioxide layer), a decorative ink layer, and a protective layer are orderly formed on the film, and the molded substrate is combined with the protective layer. The metallic layer makes the device housing present a metallic appearance. The decorative ink layer may be a two-component polyester ink layer. However, the silicon dioxide layer has a poor bond to the two-component polyester ink layer.

Therefore, there is room for improvement within the art.

### BRIEF DESCRIPTION OF THE DRAWING

Many aspects of the disclosure can be better understood with reference to the following figure. The components in the figure are not necessarily drawn to scale, the emphasis instead being placed upon clearly illustrating the principles of the disclosure.

FIG. 1 is a cross-sectional view of an exemplary embodiment of a decorative article.

FIG. 2 is a cross-sectional view of an exemplary embodiment of a device housing using the decorative article shown in FIG. 1.

### DETAILED DESCRIPTION

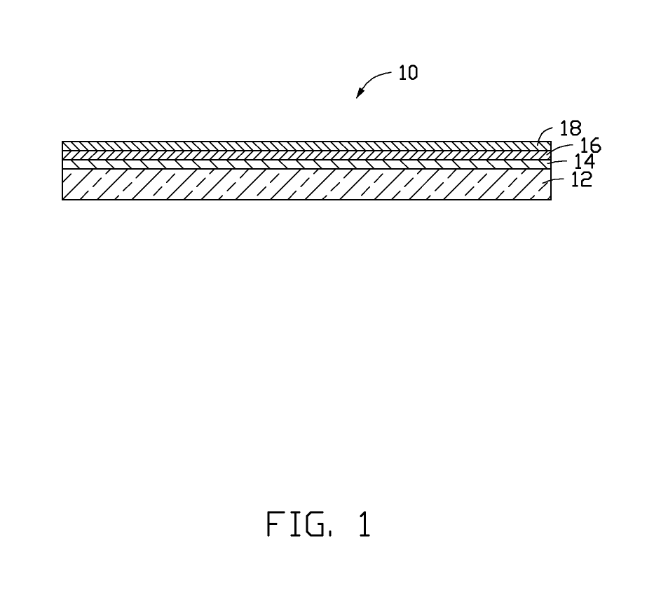

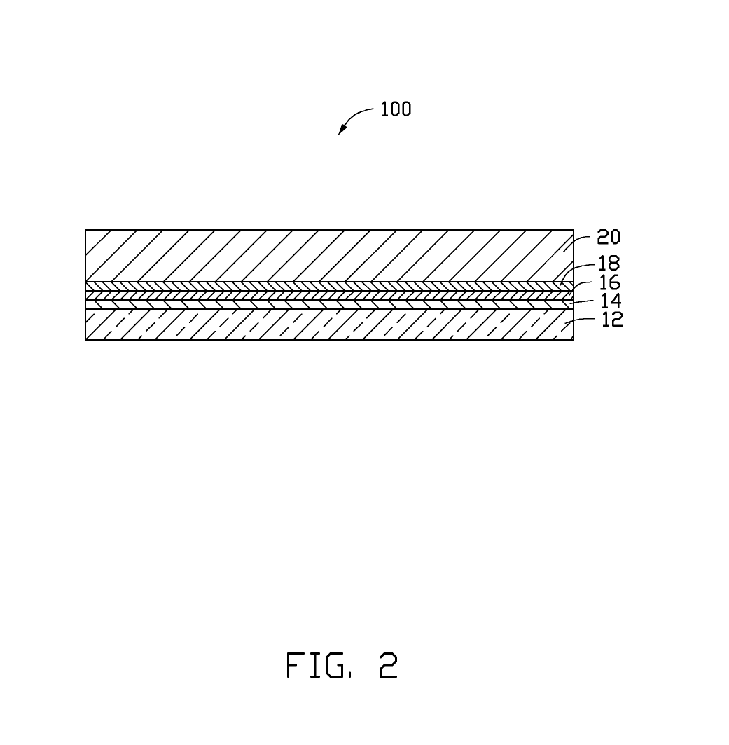

Referring to FIGS. 1 and 2, a device housing 100 according to an exemplary embodiment is shown. The device housing 100 includes a decorative article 10, and a main body 20 directly molded on the decorative article 10. As used herein, “directly” means a surface of one layer directly touches a surface of the other layer.

The decorative article 10 includes a plastic film 12, a metallic layer 14 located on the plastic film 12, a decorative ink layer 16 located on the metallic layer 14, and a protective layer 18 located on the decorative ink layer 16. The decorative ink layer 16 and the metallic layer 14 are chemically bonded with each other. Hydrogen bonds and silicon oxygen bonds are formed at the interface of the decorative ink layer 16 and the metallic layer 14. The metallic layer 14 is translucent, and provides the device housing 100 with a metallic appearance. The decorative ink layer 16 provides the device housing 100 with a colorful and/or patterned appearance.

The plastic film 12 is transparent or translucent. The plastic film 12 may be made of polyethylene terephthalate (PET), or polycarbonate (PC), for example.

The metallic layer 14 may be formed by vacuum deposition. The metallic layer 14 contains silicon oxygen bonds. In the embodiment, the metallic layer 14 is a silicon dioxide (SiO₂) layer. The SiO₂ layer has a high surface tension and high water absorption. The absorbed water breaks the silicon oxygen bonds of the SiO₂ layer at the surface of the metallic layer 14 to form more stable Si—OH groups.

The decorative ink layer 16 contains polyester ink. In the embodiment, the decorative ink layer 16 is a two-component polyester ink layer. The decorative ink layer 16 further contains siloxane coupling agent having a mass percentage of about 0.5% to about 2% in the decorative ink layer 16. The contained siloxane coupling agent at the surface of the decorative ink layer 16 hydrolyzes to form Si—OH groups. When the decorative ink layer 16 is located on the metallic layer 14, the Si—OH groups at the interface of the decorative ink layer 16 and the metallic layer 14 condensate and form stable hydrogen bonds and silicon oxygen bonds, thus enhancing the bond between the decorative ink layer 16 and the metallic layer 14.

The protective layer 18 is also an ink layer. The protective layer 18 protects the decorative ink layer 16 from being distorted during molding the main body 20.

A method for making the decorative article 10 includes the following steps.

The plastic film 12 is provided.

The metallic layer 14 is magnetron sputtered on one surface of the plastic film 12. Magnetron sputtering of the metallic layer 14 is implemented in a coating chamber of a vacuum sputtering device (not shown). The coating chamber is fixed with silicon targets. The coating chamber is evacuated to about 4.0×10⁻³ Pa. Oxygen (O₂) used as a reaction gas is fed into the coating chamber. The power is applied to the silicon targets to deposit the metallic layer 14.

The decorative ink layer 16 is printed on the metallic layer 14 and then baked in an oven (not shown) having an inner temperature of about 75° C. to about 90° C. for about 30 minutes to about 90 minutes.

The protective layer 18 is printed on the decorative ink layer 16, thus finishes the decorative article 10.

A temperature and humidity test was performed on an embodiment of the decorative article 10.

The test was carried out using a constant temperature and humidity box (not shown). The decorative article 10 is first positioned in the box. The box is heated from 25° C. to 65° C. in 1.5 hours under a humidity of about 93% to about 96% and then the temperature and the humidity are kept constant for about 4 hours. The box is then cooled from 65° C. to 30° C. in 1.5 hours under a humidity of about 95 to about 100% and then the temperature and the humidity are kept constant for about 1 hour. As such, a test circle is finished. The decorative article 10 is totally subjected to 27 constant test circles. After 27 test circles, the box is adjusted to have an inner temperature of about 25° C. and a humidity of about 70%, and the decorative article 10 is continually positioned in the box for about 2 hours.

After the test, no cracks and air bubbles were found in the decorative article 10.

It is to be understood that, the protective layer 18 is not necessary. The decorative layer 18 can be omitted and the main body 20 is directly located on the decorative ink layer 16.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A decorative article, comprising:
a plastic film;
a metallic layer located on the plastic film, and the metallic layer comprising silicon oxygen bonds; and
a decorative ink layer located on the metallic layer, and the decorative ink layer comprising polyester ink and siloxane coupling agent.

2. The decorative article as claimed in claim 1, wherein the metallic layer is a silicon dioxide layer and is translucent.

3. The decorative article as claimed in claim 1, wherein the polyester ink is two-component polyester ink.

4. The decorative article as claimed in claim 1, wherein the decorative ink layer and the metallic layer are chemically bonded with each other, hydrogen bonds and silicon oxygen bonds are present at an interface of the decorative ink layer and the metallic layer.

5. The decorative article as claimed in claim 1, wherein the siloxane coupling agent has a mass percentage of about 0.5% to about 2% in the decorative ink layer.

6. The decorative article as claimed in claim 1, wherein the decorative article further comprises a protective layer, the protective layer is located on the decorative ink layer.

7. The decorative article as claimed in claim 6, wherein the protective layer is an ink layer.

8. The decorative article as claimed in claim 1, wherein the plastic film comprises polyethylene terephthalate or polycarbonate, the plastic film is transparent or translucent.

9. A device housing, comprising:
a decorative article; and
a main body bonded with the decorative article;
wherein the decorative article comprises:
a plastic film;
a metallic layer located on the plastic film, and the metallic layer comprising silicon oxygen bonds; and
a decorative ink layer located on the metallic layer, and the decorative ink layer comprising polyester ink and siloxane coupling agent, the main body located on the decorative ink layer.

10. The device housing as claimed in claim 9, wherein the metallic layer is a silicon dioxide layer and is translucent.

11. The device housing as claimed in claim 9, wherein the polyester ink is two-component polyester ink.

12. The device housing as claimed in claim 9, wherein the decorative ink layer and the metallic layer are chemically bonded with each other, hydrogen bonds and silicon oxygen bonds are present at an interface of the decorative ink layer and the metallic layer.

13. The device housing as claimed in claim 9, wherein the siloxane coupling agent has a mass percentage of about 0.5% to about 2% in the decorative ink layer.

14. The device housing as claimed in claim 9, wherein the device housing further comprises a protective layer, the protective layer is located on the decorative ink layer, the main body bonds with the protective layer.

15. The device housing as claimed in claim 14, wherein the protective layer is an ink layer.

16. The device housing as claimed in claim 9, wherein the plastic film comprises polyethylene terephthalate or polycarbonate, the plastic film is transparent or translucent.
